(19) United States
(12) Patent Application Publication
(10) Pub. No.: US 2008/0070558 A1
(43) Pub. Date: Mar. 20, 2008

(54) System and Method for Short Code Directory

(75) Inventor: Robert C. Lovell, Leesburg, VA (US)

Correspondence Address: EDELL, SHAPIRO & FINNAN, LLC, 1901 RESEARCH BOULEVARD, SUITE 400, ROCKVILLE, MD, 20850, US

(73) Assignee: SYBASE 365, INC., Chantilly, VA (US)

(21) Appl. No.: 11/856,447

(22) Filed: Sep. 17, 2007

Related U.S. Application Data
(60) Provisional application No. 60/845,174, filed on Sep. 18, 2006.

(51) Int. Cl. H04M 3/42

(52) U.S. Cl. 455/414.1; 455/466

(57) ABSTRACT

A service that leverages established wireless messaging paradigms such as, possibly inter alia, Short Message Service, Multimedia Message Service, and IP Multimedia Subsystem to yield an infrastructure that (1) supports a comprehensive Common Short Code directory that seamlessly spans or crosses the disparate ‘islands’ of national/regional Short Code information and that offers, possibly among other things, a full-featured search capability and (2) allows a Mobile Subscriber to seamlessly employ their Wireless Device to interact with same. The service may optionally leverage the capabilities of a centrally-located Value-Added Service Provider.

This application claims the benefit of U.S. Provisional Patent Application No. 60/845,174, filed on Sep. 18, 2006, which is herein incorporated by reference in its entirety.

### BACKGROUND

1. Field of the Invention

The present invention relates generally to telecommunications services. More particularly, the present invention relates to capabilities that enhance substantially the value and usefulness of various wireless messaging paradigms including, inter alia, Short Message Service (SMS), Multimedia Message Service (MMS), etc.

2. Background of the Invention

As the ‘wireless revolution’ continues to march forward the importance to a Mobile Subscriber (MS), for example a user of a Wireless Device (WD) such as a cellular telephone, BlackBerry, etc. that is serviced by a Wireless Carrier [WC], of their WD grows substantially.

One consequence of such a growing importance is the resulting ubiquitous nature of WDs—i.e., MSs carry them at almost all times and use them for an ever-increasing range of activities.

Coincident with the growing prevalence and use of WDs has been the rapid evolution of Short Codes (SCs)—i.e., brief or abbreviated often easily-remembered numbers (e.g., such as 46645 for ‘GOOGL’ on a numeric keypad) to which, for example, SMS/MMS/etc. messages may be directed for any number of search, game, Mobile Commerce, voting, etc. activities.

In support of the assignment (e.g., the sale, lease, etc.), the use, etc. of SCs a national or regional administration facility has traditionally been established in each individual country—e.g., an administration facility in Australia, an administration facility in Canada, an administration facility in the United States, etc.

Each individual administration facility provides management, etc. services for the universe of SCs that all of the WCs or operators within its nation/region have agreed to honor—i.e., universal or Common Short Codes (CSCs), SCs that are recognized by, and that are therefore applicable across, multiple WCs or operators. A description of aspects of an exemplary administration facility may be found in pending U.S. patent application Ser. No. 10/742,764 entitled “UNIVERSAL SHORT CODE ADMINISTRATION FACILITY,” which is incorporated herein by reference.

The separate CSC administration facilities result in disparate (national or regional) ‘islands’ of CSC assignment, use, etc. information.

Additionally, the individual CSC administration facilities offer few, if any, search capabilities (e.g., “show me all of the provisioned or available CSCs that are associated with a television voting campaign such as American Idol”, “show me all of the provisioned or available CSCs that provide search services”, etc.).

What is needed is a comprehensive CSC directory that seamlessly spans or crosses the disparate ‘islands’ of national/regional information and that offers, among other things, a full-featured search capability.

The present invention provides such a directory (and, among other things, such a search capability) and addresses various of the (not insubstantial) challenges that are associated with same.

### SUMMARY OF THE INVENTION

Embodiments of the present invention provide a service that leverages established wireless messaging paradigms such as, possibly inter alia, SMS and MMS to yield an infrastructure that, in one embodiment, accumulates common short code (CSC) data from a plurality of nationally disparate CSC Administrators, and arranges and stores the same in a database. A search request related to a CSC is subsequently received and the database is queried for information related to the CSC. Finally, a reply message is generated and sent based on information retrieved from the database.

In one possible implementation the CSC data includes information such as country identification, identification of a CSC Administrator, and a function of a given CSC. The function may be, e.g., “search” or “sports.”

In a possible implementation, the search request is sent wirelessly, by, e.g., the short message service (SMS) or the multimedia service (MMS). A keyword, as well as wildcard characters, may be included as part of the search request.

At least a portion of content of the reply message may be made available via channel that is different from a channel via which the search request was sent. Thus, for example, the search request may be sent via the short message service (SMS) and the content of the reply message may be made available via the world wide web (WWW).

In an implementation, the method may provide for hosting and managing a quick list of CSCs for a user, as well as alerting a user when, in response to previously supplied user information, a CSC becomes newly-available. The method may further provide for billing a user for CSC management service.

In still another embodiment of the present invention, there is provided a method of managing a short code directory by arranging communications with a plurality of nationally disparate Common Short Code (CSC) Administrators, obtaining from the nationally disparate CSC Administrators information about short codes being respectively managed by the nationally disparate CSC Administrators, aggregating the information about the short codes in a database, and providing access to the information about the short codes via queries received from third parties.

These and other features of the embodiments of the present invention, along with their attendant advantages, will be more fully appreciated upon a reading of the following detailed description in conjunction with the associated drawings.

### BRIEF DESCRIPTION OF THE DRAWINGS

FIG. 1 depicts an exemplary local data model that a Service Provider (SP) might employ to support aspects of the present invention.

FIG. 2 is a diagrammatic presentation of an exemplary Value-Added Service Provider (VASP).

FIG. 3 illustrates one particular arrangement that is possible through aspects of the present invention.

FIG. 4 illustrates various of the exchanges or interactions that are supported by aspects of the present invention.

FIG. 5 depicts an exemplary data model for an aspect of the present invention.

FIG. 6 is a diagrammatic presentation of aspects of an exemplary SP Application Server (AS).

It should be understood that these figures depict embodiments of the invention. Variations of these embodiments will be apparent to persons skilled in the relevant art(s) based on the teachings contained herein.

### DETAILED DESCRIPTION

As noted above, SCs are brief or abbreviated often easily-remembered numbers (e.g., such as 46645 for ‘GOOGL’ on a numeric keypad) to which, for example, SMS/MMS/etc. messages may be directed for any number of activities or purposes. SCs have traditionally been local to each WC or operator—i.e., a given SC (such as, for example, 41100) may be associated with an information service within one WC or operator, may have an entirely different assigned use within another WC or operator, and may be unassigned (not in use) within yet another WC or operator.

To provide broader (e.g., inter-WC or inter-operator) coverage the concept of a CSC was born. A CSC is, in brief, a SC that spans multiple WCs or operators—i.e., a SC that is recognized by, and that is therefore applicable across, multiple WCs or operators.

CSCs are traditionally national or regional. Consequently CSC administration facilities (that handle such things as assignment [sale, lease, etc.], use, etc.) have been established in individual countries—e.g., in Canada (on the World Wide Web [WWW] at the domain www.Txt.ca), in the United States (on the WWW at the domain www.USShortCodes.com), etc.

The separate CSC administration facilities result in multiple disparate (national or regional) ‘islands’ of assignment, use, etc. information.

The present invention provides a comprehensive directory that seamlessly spans or crosses the multiple disparate ‘islands’ of national/regional information and offers, among other things, a full-featured search capability.

The comprehensive directory, and all of the associated services (such as search), may be offered by a SP. A SP may, for example, be realized as a third-party (e.g., a service bureau), be an element of a WC or a landline carrier, be two or more third-party entities working together, etc.

A SP may elect to store the entire contents of the comprehensive directory locally within its systems, it may elect to store nothing locally and instead ‘go out to’ one or more CSC administrators (to retrieve information) each time that it needs some information, or it may elect to implement a solution that employs some combination of the above.

A SP may ‘go out to’ a CSC administrator (to retrieve information) on a scheduled basis, on an as-needed basis, or some combination of the above.

A SP may ‘go out to’ a CSC administrator (to retrieve information) through an open means (such as, inter alia, the WWW), through a closed means (such as, inter alia, a dedicated connection), or through some combination of the above.

A SP may communicate or interact with a CSC administrator through an Application Programming Interface (API).

Each time that a SP retrieves information from a CSC administrator it may optionally preserve some or all of the results locally (within its systems).

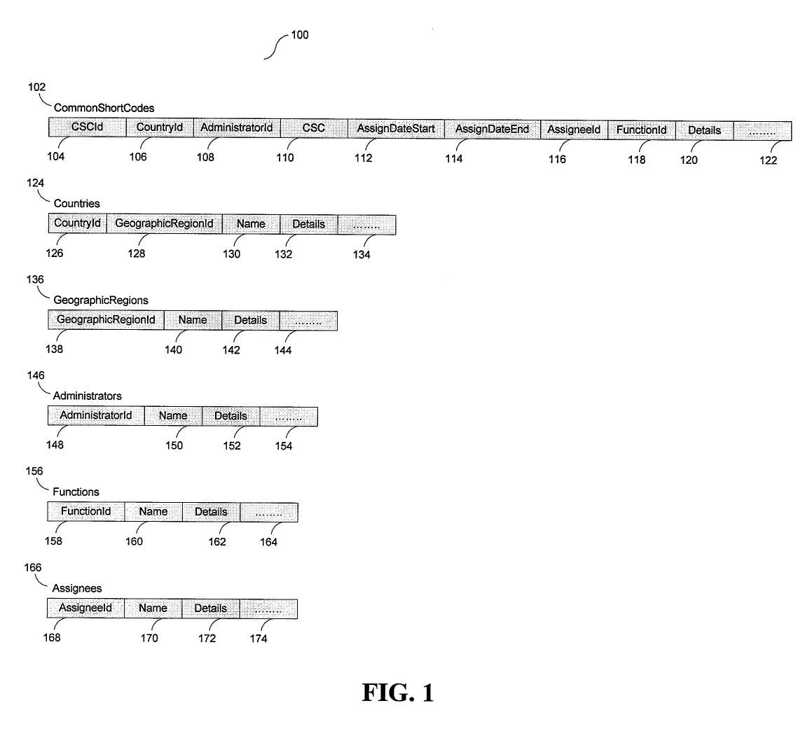

FIG. 1 and reference numeral 100 depict an exemplary local data model that a SP might employ to support aspects of the present invention.

A GeographicRegions table 136 might contain a list of geographic regions of the world such as defined by the International Telecommunication Union (ITU). For example:

| GeographicRegionId 136 | Name 140 |
|---|---|
| 1 | North America |
| 2 | Africa |
| 3 | Europe |
| 4 | Europe |
| 5 | South America |
| 6 | Australia, etc. |
| 7 | USSR |
| 8 | Eastern Asia |
| 9 | Westem Asia, Middle East |

A Countries table 124 might contain a list of countries in the world such as defined by the ITU. For example:

| CountryId 126 | Name 128 |
|---|---|
| 0 | Reserved |
| 1 | North America |
| 20 | Egypt |
| 212 | Morocco |
| . | |
| 44 | United Kingdom of Great Britain and Northern Ireland |
| . | |
| 98 | Iran |
| . | |
| 999 | Reserved |

An Administrators 146 table might contain a list of all of the national/regional CSC administrators around the world.

A Functions 156 table might contain a list of all of the identified CSC functions or purposes such as, inter alia, Search, Vote, Contest, Game, Chat, News, Sports, Traffic, Travel, etc.

An Assignees 166 table might contain a list of all of the identified CSC assignees, owners, etc.

A CommonShortCodes 102 table might contain a list of all of the identified assigned, leased, etc. CSCs.

The specific table structures that are presented in FIG. 1 and reference numeral 100 are illustrative only and it will be readily apparent to one of ordinary skill in the relevant art that numerous other tables and/or table structures are easily possible and indeed are fully within the scope of the present invention. For example, the data model may optionally contain a set of history tables in order to preserve the details (such as, inter alia, date, time, source, nature, etc.) of any changes that are made to the contents of the data model—e.g., as one possible example, when through a CSC administrator the assignment or the lease of a CSC is changed.

A SP may populate the tables of the exemplary local data model through any combination of different means including, inter alia, periodic scheduled data feeds from CSC administrators, scheduled and/or on-demand retrieval of (comma delimited, text, etc.) data file(s) from CSC administrators, scheduled and/or on-demand (screen scraping, programmatic, etc.) inquiries to CSC administrators, etc.

A SP may offer access to its directory (and access to various of its related services such as search) through any number of different channels including, inter alia, wireless messaging (e.g., SMS/MMS/etc.), the WWW, electronic mail (e-mail), Instant Messaging (IM), telephone, Interactive Voice Response (IVR) facilities, an API, etc.

For purposes of illustration consider the following discussion of a wireless messaging (e.g., SMS/MMS/etc.) channel.

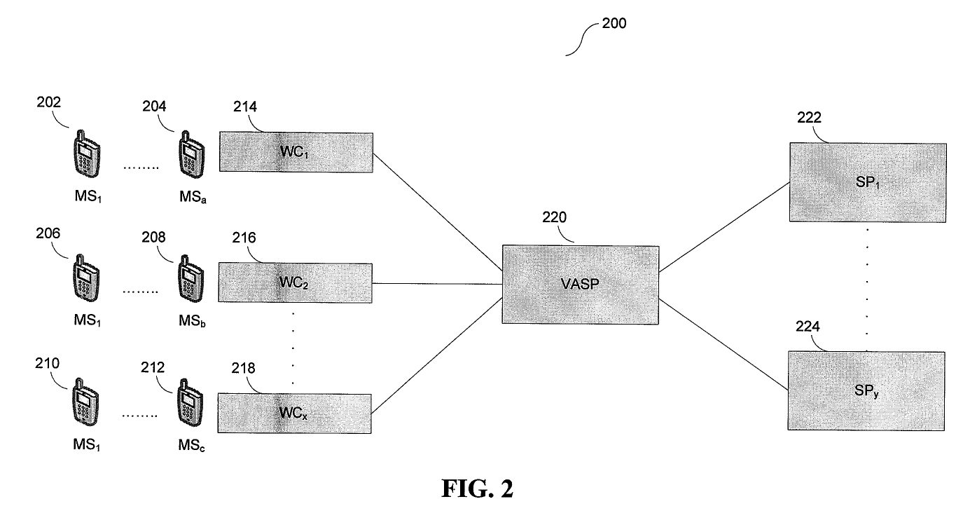

This approach may leverage the capabilities of a centrally-located, full-featured VASP facility. As illustrated by FIG. 2 and reference numeral 200 a VASP 220 is disposed between, possibly inter alia, multiple WCs (WC₁ 214→WCₓ 218) on one side and multiple SPs (SP₁ 222→SP_{y} 224) on the other side and thus ‘bridges’ all of the connected entities. A VASP 220 thus, as one simple example, may offer various routing, formatting, delivery, value-add, etc. capabilities that provide, possibly inter alia:

1) A WC, WC₁ 214→WCₓ 218 (and by extension all of the MSs [MS₁ 202→MSₐ 204, MS₁ 206→MS_{b} 208, MS₁ 210→MS_{c} 212] that are serviced by a WC [WC₁ 214→WCₓ 218]), with ubiquitous access to a broad universe of SPs (SP₁ 222→SP_{y} 224), and

2) A SP (SP₁ 222→SP_{y} 224) with ubiquitous access to a broad universe of WCs (WC₁ 214→WCₓ 218 and, by extension, to all of the MSs [MS₁ 202→MSₐ 204, MS₁ 206→MS_{b}208, MS₁ 210→MS_{c} 212] that are serviced by a WC [WC₁ 214→WCₓ 218]).

Generally speaking a VASP may have varying degrees of visibility (e.g., access, etc.) to the (MS←→MS, MS←→SP, etc.) messaging traffic:

1) A WC may elect to route just their out-of-network messaging traffic to a VASP. Under this approach the VASP would have visibility (e.g., access, etc.) to just the portion of the WC's messaging traffic that was directed to the VASP by the WC.

2) A WC may elect to route all of their messaging traffic to a VASP. The VASP may, possibly among other things, subsequently return to the WC that portion of the messaging traffic that belongs to (i.e., that is destined for a MS of) the WC. Under this approach the VASP would have visibility (e.g., access, etc.) to all of the WC's messaging traffic.

While the discussion below will include a VASP it will be readily apparent to one of ordinary skill in the relevant art that numerous other arrangements are equally applicable and indeed are fully within the scope of the present invention.

To better understand the particulars of the present invention consider for a moment a simple hypothetical example—SP SPₓ offers a comprehensive directory along with services (such as search) as provided through the instant invention and Mary, a MS, uses SPₓ's service.

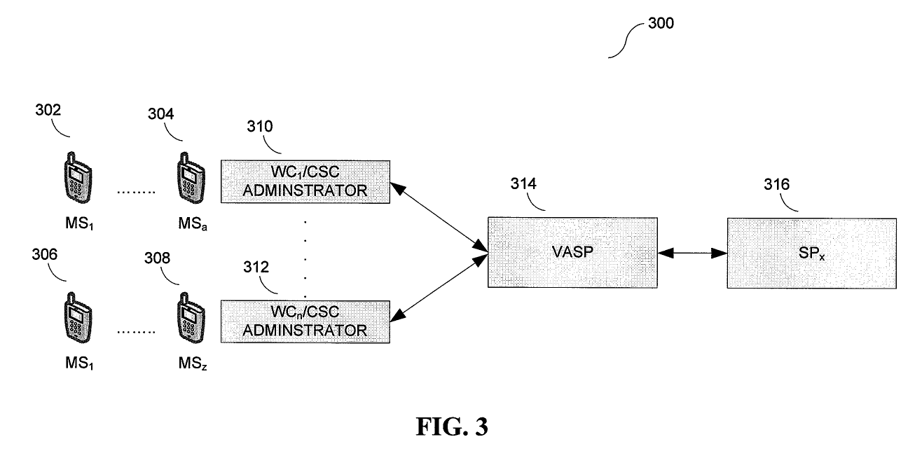

FIG. 3 and reference numeral 300 depict one possible arrangement under which our hypothetical example might operate. In brief, a number of MSs (MS₁ 302→MSₐ 304 and MS₁ 306→MS_{z} 308, including Mary) may interact, in rich and complete ways, with the services, capabilities, etc. that are offered by SPₓ 316. FIG. 3 further depicts that WCs (310, 312), themselves, may operate as a CSC Administrator. However, those skilled in the art will appreciate that the CSC Administrator functionality may be performed by a separate and distinct entity that covers multiple wireless carriers in an entire country or region, as described earlier herein. Thus, FIG. 3 is meant to broadly depict connectivity among several entities in accordance with the present invention. In this regard, where elements/entities 310, 312 function as CSC Administrators only, such entities may not be in communication with individual WDs of MSs.

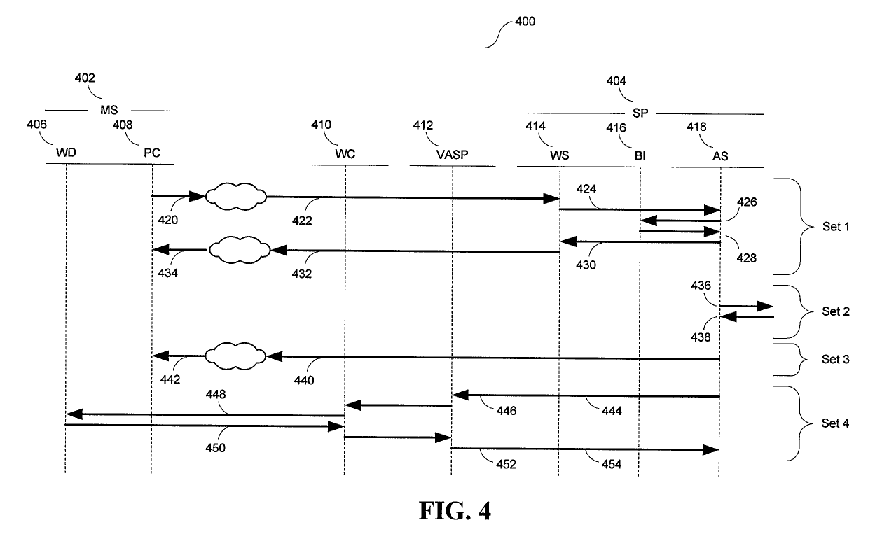

FIG. 4 and reference numeral 400 illustrate various of the exchanges or interactions that might occur under a portion of our hypothetical example. Of interest and note in the diagram are the following entities:

MS 402 WD 406. For example, Mary's WD such as a cellular telephone, BlackBerry, PalmPilot, etc.

MS 402 Personal Computer (PC) 408. For example, one of Mary's home, work, etc. PCs.

WC 410. The provider of service for Mary's WD 408.

VASP 412. As noted above the use of a VASP, although not required, provides significant advantages.

SP 404 Web Server (WS) 414. A publicly-available WWW site that is optionally provided by SPₓ.

SP 404 Billing Interface (BI) 416. A single, consolidated interface that SPₓ may use to easily reach, inter alia, one or more external entities such as a credit card or debit card clearinghouse, a carrier billing system, a service bureau that provides access to multiple carrier billing systems, etc.

SP 404 AS 418. Facilities that provide key elements of the instant invention (which will be described below).

It is important to note that while in FIG. 4 the MS 402 WD 406 and MS 402 PC 408 entities are illustrated as being adjacent or otherwise near each other in actual practice the entities may, for example, be physically located anywhere.

It is also important to note or observe that:

1) In the instant example the messages are shown traversing a VASP 412.

2) The SP 404 may employ a CSC or a regular Telephone Number (TN) as its source address (and to which it would ask users of its service to direct any messages).

Additionally, in the discussion below reference is made to messages that are sent, for example, between a MS and a SP. As set forth below, a given ‘message’ sent between a MS and a SP may actually comprise a series of steps in which the message is received, forwarded and routed between different entities, including possibly inter alia a MS, a WC, a VASP, and a SP. Thus, unless otherwise indicated, it will be understood that reference to a particular message generally includes that particular message as conveyed at any stage between an origination source, such as for example a MS, and an end receiver, such as for example a SP. As such, reference to a particular message generally includes a series of related communications between, for example, a MS and a WC; a WC and a VASP; a VASP and a SP; etc. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

In FIG. 4 the exchanges that are collected under the designation Set 1 represent the activities that might take place as Mary 402 completes an optional registration process with SPₓ 404. For example:

A) Mary 402 uses one of her PCs 408 to visit SPₓ's 404 WS 414 to, possibly among other things, complete a service registration process (420→422).

B) SPₓ's 404 WS 414 interacts with SPₓ's 404 AS 414 to, possibly among other things, commit some or all of the information that Mary 402 provided to a data repository (e.g., a database), optionally complete a billing transaction, etc. (424).

C) As appropriate and as required a BI 416 completes a billing transaction (426→428).

D) SPₓ's 404 WS 414 responds appropriately (e.g., with the presentation of a confirmation message, etc.) (432→434).

The specific exchanges that were described above (as residing under the designation Set 1) are illustrative only and it will be readily apparent to one of ordinary skill in the relevant art that numerous other exchanges are easily possible and indeed are fully within the scope of the present invention. As just one example, the registration process may be completed through any combination of one or more channels including, inter alia, the indicated WWW facility, wireless messaging (SMS, MMS, IP Multimedia Subsystem [IMS], etc.), e-mail messages, IM exchanges, conventional mail, telephone, IVR facilities, etc.

During the registration process that was described above a range of information may be captured from a MS including, inter alia:

1) Identifying Information (e.g., general information about Mary). For example, possibly among other things, a unique identifier and a password, optionally a pseudonym or handle, name, contact information (such as WD TN[s], e-mail address[es], etc.), physical address, etc.

2) Billing Information. Different service billing models may be offered by SPₓ including, possibly inter alia, free (e.g., possibly advertising-based), a fixed one-time charge, a recurring (hourly, daily, monthly, etc.) fixed charge, a recurring (hourly, daily, monthly, etc.) variable charge, a per-use charge, etc. Different payment mechanisms may be supported by SPₓ including, possibly among other things, credit or debit card information, authorization to place a charge on a MS's phone bill, etc.

3) Other Information. Additional, possibly optional, information such as age, sex, preferences and interests, etc.

The specific pieces of information that were described above are illustrative only and it will be readily apparent to one of ordinary skill in the relevant art that numerous other pieces of information are easily possible and indeed are fully within the scope of the present invention.

As noted above the information that Mary provided during the registration process may be preserved in a data repository (e.g., a database) and may optionally be organized as a MS Profile.

The content of Mary's profile may optionally be augmented by SPₓ. For example, one or more internal or external sources of consumer, demographic, psychographic, etc. information may be leveraged to selectively enhance or augment elements of Mary's profile.

As noted above, a SP's BI may optionally complete one or more billing transactions. A billing transaction may take any number of forms and may involve different external entities (e.g., a WC's billing system, a carrier billing system service bureau, a credit or debit card clearinghouse, etc.). A billing transaction may include, inter alia:

1) The appearance of a line item charge on the bill or statement that a MS receives from her WC. Exemplary mechanics and logistics associated with this approach are described in pending U.S. patent application Ser. No. 10/837,695 entitled “SYSTEM AND METHOD FOR BILLING AUGMENTATION,” which is incorporated herein by reference in its entirety. Other ways of completing or performing line item billing are easily implemented by those skilled in the art.

2) The charging of a credit card or the debiting of a debit card.

In FIG. 4 the exchanges that are collected under the designation Set 2 represent the activities that might take place as SPₓ 404 optionally coordinates, etc. with one or more external entities to, possibly among other things, secure access, arrange to receive updates, etc. (436→438).

The specific exchanges that were described above (as residing under the designation Set 2) are illustrative only and it will be readily apparent to one of ordinary skill in the relevant art that numerous other exchanges (including, inter alia, updates to various of the information in a MS Profile in a SP's repository, etc.) are easily possible and indeed are fully within the scope of the present invention.

In FIG. 4 the exchanges that are collected under the designation Set 3 represent the activities that might take place as SPₓ 404 dispatches to Mary 402 one or more confirmation E-mail messages (440→442).

The specific exchanges that were described above (as residing under the designation Set 3) are illustrative only and it will be readily apparent to one of ordinary skill in the relevant art that numerous other exchanges (including, inter alia, other types or forms of confirmation messages) are easily possible and indeed are fully within the scope of the present invention.

In FIG. 4 the exchanges that are collected under the designation Set 4 represent the activities that might take place as SPₓ's 404 AS 418 dispatches one or more confirmation SMS, MMS, IMS, etc. messages (444→448) to Mary's 402 WD 406 and Mary 402 replies or responds to the message(s) (450→454). In the instant example the messages are shown traversing a VASP 412. The SP 404 may employ a SC or a regular TN as its source address (and to which it would ask users of its service to direct any reply messages).

The specific exchanges that were described above (as residing under the designation Set 4) are illustrative only and it will be readily apparent to one of ordinary skill in the relevant art that numerous other exchanges are easily possible and indeed are fully within the scope of the present invention.

The Set 1, Set 2, Set 3, and Set 4 exchanges that were described above are illustrative only and it will be readily apparent to one of ordinary skill in the relevant art that numerous other exchanges are easily possible and indeed are fully within the scope of the present invention.

The information that was described above may be subsequently managed (e.g., existing information may be edited or removed, new information may be added, etc.) through any combination of one or more channels including, inter alia, a SP's WWW facility, wireless messaging (SMS, MMS, IMS, etc.), E-mail messages, IM exchanges, conventional mail, telephone, IVR facilities, etc.

To continue with our hypothetical example . . . After completing the registration process Mary may submit one or more search requests. A search request:

1) May be submitted through any combination of one or more channels including, inter alia, a SP's WWW facility, wireless messaging (SMS, MMS, etc.), E-mail messages, IM exchanges, etc. Search requests that are submitted via wireless messaging (SMS, MMS, etc.) may be directed to a conventional TN or to a CSC (such as, for example, 41100).

2) May contain, inter alia, one or more keywords, one or more CSC functions, one or more date/time ranges, one or more CSCs, etc.

3) May optionally make use of wildcards (such as, for example with a CSC, 46* or *46* or 46??? or ?46?? or etc.).

After receiving a search request a SP may, inter alia, (a) perform any number of processing activities including, inter alia, querying its local data model, querying one or more CSC administrators, etc. and (b) return one or more responses. For example, a search request that was submitted via wireless messaging (SMS, MMS, etc.) may result in a SP dispatching one or more response (SMS, MMS, etc.) messages.

A SP may optionally preserve, for example in one or more of its local repositories, selected details of one or more elements of a submitted search—e.g., the search itself, all of a SP's internal processing activities, and all of the generated responses.

A SP may allow a user to iteratively refine their search through, as just one example, the quick conveyance to the SP of the appropriate (new, different, further, etc.) search criteria.

A SP may allow a user of their search service to (without loss of state) seamlessly switch between channels. (A SP may condition such a capability on a user's previous completion of a registration process.) For example, a user might submit a search request via wireless messaging (SMS, MMS, etc.) and receive one or more response messages, then visit a SP's public WWW site and ‘pick up’ the search process where it was previously left, then revert back to a wireless messaging (SMS, MMS, etc.) channel to resume and subsequently complete the search process.

A SP may optionally offer a user such as Mary the ability to create, and subsequently use and manage, a Quick List—i.e., a list, that is specific to a user, of one or more CSCs that are of interest to the user.

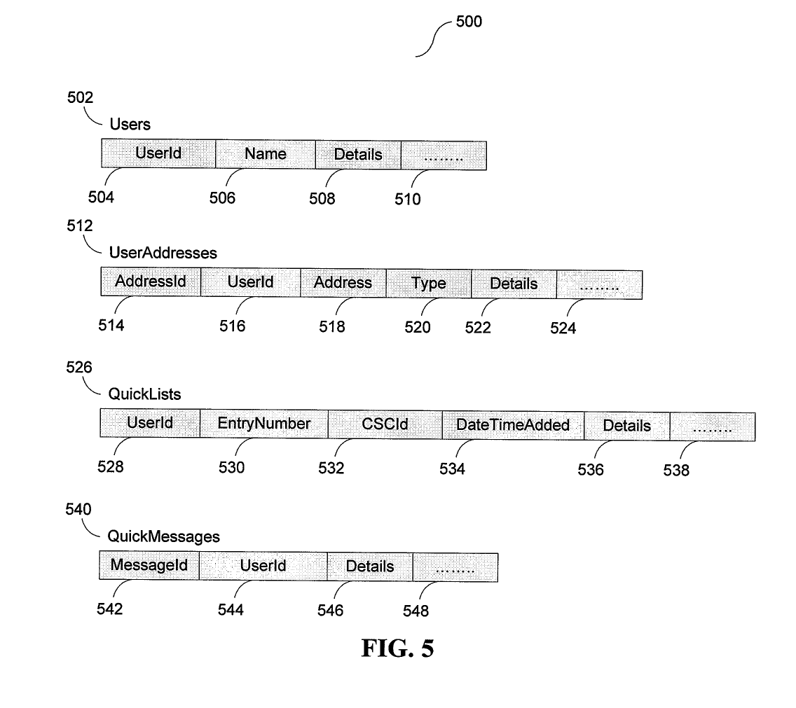

A SP may offer Quick Lists only to those users who have previously completed a registration process (so as to, for example, associate a user's Quick List to the user's profile that was created during the registration process). FIG. 5 and reference numeral 500 depicts an exemplary local data model that a SP might employ under such a circumstance.

A user may access (e.g., retrieve the contents of), manage (e.g., add, edit, and/or update the entries in), etc. their Quick List through any number of channels including, inter alia, wireless messaging (e.g., SMS/MMS/etc.), the WWW, e-mail, IM, etc.

For purposes of illustration, a hypothetical Quick List might be presented to a user (through whatever channel was selected by the user) as:

| Entry # | CSC | Function | Description |
|---|---|---|---|
| 1 | 46645 | Search | Google search |
| 2 | 10806 | Sports | SportsLine information |
| 3 | 22565 | Alert | Comedy Central daily alert |

In connection with a Quick List a SP may optionally offer a user a Quick Send capability where a user may identify a specific entry in their Quick List (by, inter alia, list entry number) and optionally convey any message content (as appropriate and as required). A SP can then generate and dispatch the appropriate SMS/MMS/etc. message(s). An SP may optionally preserve the particulars of such generated messages (in, as an illustrative example, a QuickMessages table 540 as depicted in FIG. 5).

A SP may optionally alert a user to the appearance of a new CSC that matches a user's “preferences and interests” as identified by the user during their registration process. Matches may be identified using, possibly inter alia, one or more dynamically configurable criteria. Such alerts may be dispatched through any combination of one or more channels including, inter alia, wireless messaging (e.g., SMS/MMS/etc.), the WWW, e-mail, IM, etc. A SP may optionally allow a user to add (by, as just one example, simply replying to an alert) an (alert) identified CSC to the user's Quick List.

A SP may optionally generate scheduled (e.g., daily, weekly, etc.) and/or on-demand activity, status, result, etc. reports with generated reports delivered through SMS, MMS, IMS, etc. messages; through e-mail; through a Web-based facility; etc.

A SP may optionally perform one or more incremental billing operations as it completes, for example, the various processing activities that were described above. An incremental billing operation may be triggered by configurable thresholds such as, possibly inter alia, total inbound and/or outbound message count, individual or aggregate inbound and/or outbound message volume, a (CSC, country, etc.) specific fee or charge, value-add services provided, etc. A SP may optionally preserve some or all of any such activities within, for example, one of its database, etc. environments and may optionally alert a user through one or more channels (such as SMS/MMS/etc. messages, IM messages, e-mail messages, etc.).

The (confirmation, response, report, alert, etc.) message(s) that were described above may optionally contain an informational element—e.g., a public service announcement, a relevant or applicable factoid, etc. The informational element may be selected statically (e.g., all generated messages are injected with the same informational text), randomly (e.g., a generated message is injected with informational text that is randomly selected from a pool of available informational text), or location-based (i.e., a generated message is injected with informational text that is selected from a pool of available informational text based on the current physical location of the recipient of the message as derived from, as one example, a Global Positioning System (GPS)/Location-Based Services (LBS) facility).

A SP may optionally allow advertisers to register and/or provide (e.g., directly, or through links/references to external sources) advertising content.

The message(s) that were described above may optionally contain advertising—e.g., textual material if an SMS model is being utilized, multimedia (images of brand logos, sound, video snippets, etc.) material if an MMS model is being utilized, etc. The advertising material may be selected statically (e.g., all generated messages are injected with the same advertising material), randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a GPS/LBS facility).

The message(s) that were described above may optionally contain promotional materials (e.g., text, still images, video clips, etc.).

The discussion that was just presented referenced the specific wireless messaging paradigms SMS and MMS. However, as noted previously it is to be understood that it would be readily apparent to one of ordinary skill in the relevant art that numerous other paradigms (including, inter alia, IM, e-mail, IMS, Wireless Application Protocol [WAP], etc.) are fully within the scope of the present invention.

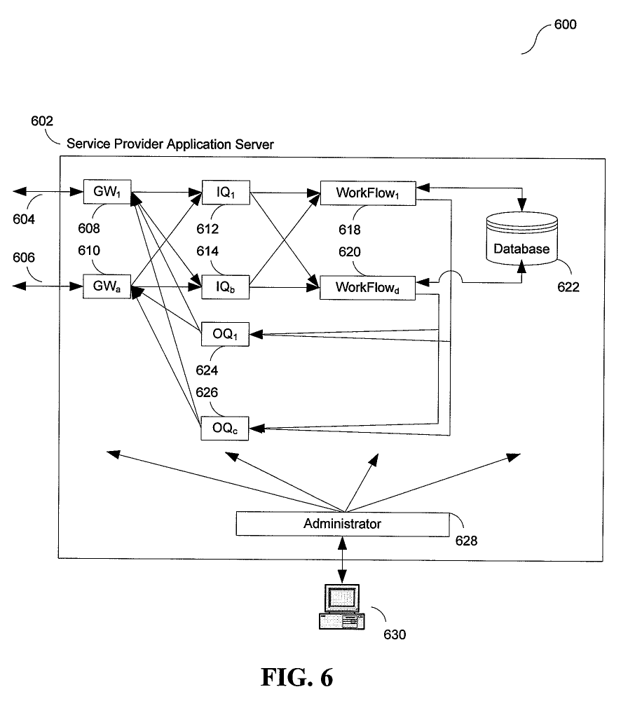

FIG. 6 and reference numeral 600 provide a diagrammatic presentation of aspects of an exemplary SP AS 602. The illustrated AS 602 contains several key components—Gateways (GW₁ 608→GWₐ 610 in the diagram), Incoming Queues (IQ₁ 612→IQ_{b} 614 in the diagram), WorkFlows (WorkFlow₁ 618→WorkFlow_{d} 620 in the diagram), Database 622, Outgoing Queues (OQ₁ 624→OQ_{c} 626 in the diagram), and an Administrator 628. It will be readily apparent to one of ordinary skill in the relevant art that numerous other components are possible within an AS 602.

A dynamically updateable set of one or more Gateways (GW₁ 608→GWₐ 610 in the diagram) handle incoming (e.g., SMS/MMS/IMS/etc. messaging, CSC data, etc.) traffic and outgoing (e.g., SMS/MMS/IMS/etc. messaging, etc.) traffic. Incoming traffic is accepted and deposited on an intermediate or temporary Incoming Queue (IQ₁ 612→IQ_{b} 614 in the diagram) for subsequent processing. Processed artifacts are removed from an intermediate or temporary Outgoing Queue (OQ₁ 624→OQ_{c} 626 in the diagram) and then dispatched.

A dynamically updateable set of one or more Incoming Queues (IQ₁ 612→IQ_{b} 614 in the diagram) and a dynamically updateable set of one or more Outgoing Queues (OQ₁ 624→OQ_{c} 626 in the diagram) operate as intermediate or temporary buffers for incoming and outgoing traffic.

A dynamically updateable set of one or more WorkFlows (WorkFlow₁ 618→WorkFlow_{d} 620 in the diagram) remove incoming traffic from an intermediate or temporary Incoming Queue (IQ₁ 612→IQ_{b} 614 in the diagram), perform all of the required processing operations (more about this below), and deposit processed artifacts on an intermediate or temporary Outgoing Queue (OQ₁ 624→OQ_{c} 626 in the diagram).

The Database 622 that is depicted in FIG. 6 is a logical representation of the possibly multiple physical repositories that may be implemented to support, inter alia, configuration, profile, monitoring, alerting, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

As depicted in FIG. 6 an Administrator 628 provides management or administrative control over all of the different components of an AS 602 through, as one example, a WWW-based interface 630. It will be readily apparent to one of ordinary skill in the relevant art that numerous other interfaces (e.g., a data feed, an Application Programming Interface [API], etc.) are easily possible.

Through flexible, extensible, and dynamically updatable configuration information a WorkFlow component may be quickly and easily realized to support any number of activities. For example, WorkFlows might be configured to support the registration of a MS; the extraction of data values from an incoming message; the editing/validation of data values; the enhancement/augmentation of data values; an array of analysis operations; the satisfaction of search requests; the generation and dispatch of reply messages; the specification and maintenance of Quick Lists; the generation and dispatch of Quick Send messages; the generation of scheduled and/or on-demand reports; the interaction with a CSC administrator; the interaction with external and/or internal sources of data or information; etc. The specific WorkFlows that were just described are exemplary only; it will be readily apparent to one of ordinary skill in the relevant art that numerous other WorkFlow arrangements, alternatives, etc. are easily possible.

A SP may maintain a repository (e.g., a database) into which selected details of all administrative, messaging, etc. activities may be recorded. Among other things, such a repository may be used to support:

1) Scheduled (e.g., daily, weekly, etc.) and/or on-demand reporting with report results delivered through SMS, MMS, IMS, etc. messages; through E-Mail; through a WWW-based facility; etc.

2) Scheduled and/or on-demand data mining initiatives (possibly leveraging or otherwise incorporating one or more external data sources) with the results of same presented through Geographic Information Systems (GISs), visualization, etc. facilities and delivered through SMS, MMS, IMS, etc. messages; through E-Mail; through a WWW-based facility; etc.

The discussion that was just presented referenced the specific wireless messaging paradigm SMS. This paradigm potentially offer an incremental advantage over other paradigms in that native support may commonly be found on a WD that a potential MS would be carrying. However, it is to be understood that it would be readily apparent to one of ordinary skill in the relevant art that other paradigms (MMS, IMS, WAP, etc.) are fully within the scope of the present invention.

It is important to note that the hypothetical example that was presented above, which was described in the narrative and which was illustrated in the accompanying figures, is exemplary only. It is not intended to be exhaustive or to limit the invention to the specific forms disclosed. It will be readily apparent to one of ordinary skill in the relevant art that numerous alternatives to the presented example are easily possible and, indeed, are fully within the scope of the present invention.

The following list defines acronyms as used in this disclosure.

| Acronym | Meaning |
|---|---|
| API | Application Programming Interface |
| AS | Application Server |
| BI | Billing Interface |
| CSC | Common Short Code |
| DBMS | Database Management System |
| GIS | Geographic Information System |
| GPS | Global Positioning System |
| GW | Gateway |
| IM | Instant Messaging |
| IMS | IP Multimedia Subsystem |
| IQ | Incoming Queue |
| ITU | International Telecommunication Union |
| IVR | Interactive Voice Response |
| LBS | Location Based Services |
| MMS | Multimedia Message Service |
| MS | Mobile Subscriber |
| ODBMS | Object Database Management System |
| OQ | Outgoing Queue |
| RDBMS | Relational Database Management System |
| RSS | Really Simple Syndication |
| SC | Short Code |
| SMS | Short Message Service |
| SP | Service Provider |
| TN | Telephone Number |
| VASP | Value-Added Service Provider |
| WAP | Wireless Application Protocol |
| WC | Wireless Carrier |
| WD | Wireless Device |
| WS | Web Server |
| WWW | World Wide Web |

What is claimed is:

1. A method of managing common short codes (CSCs), comprising:
accumulating common short code (CSC) data from a plurality of nationally disparate CSC Administrators, and arranging and storing the same in a database;
receiving a search request related to a CSC;
querying the database for information related to the CSC; and
generating and sending a reply message related to the CSC based on information retrieved from the database.

2. The method of claim 1, wherein the CSC data includes a country identification.

3. The method of claim 1, wherein the CSC data includes an identification of a CSC Administrator.

4. The method of claim 1, wherein the CSC data includes a function of a given CSC.

5. The method of claim 4, wherein the function comprises at least one of search and sports.

6. The method of claim 1, wherein the search request is sent wirelessly.

7. The method of claim 6, wherein the search request is sent as a short message service (SMS) message.

8. The method of claim 6, wherein the search request is sent as a multimedia service (MMS) message.

9. The method of claim 1, further comprising processing a keyword received as part of the search request.

10. The method of claim 9, wherein a wildcard is received as part of the search request.

11. The method of claim 1, further comprising making at least a portion of content of the reply message available via channel that is different from a channel via which the search request was sent.

12. The method of claim 11, wherein the search request is sent via the short message service (SMS) and the content of the reply message is made available via the world wide web (WWW).

13. The method of claim 1, further comprising hosting and managing a quick list of CSCs for a user.

14. The method of claim 1, further comprising alerting a user when, in response to previously supplied user information, a CSC becomes newly-available.

15. The method of claim 1, further comprising billing a user for CSC management service.

16. A method of managing a short code directory, comprising:
arranging communications with a plurality of nationally disparate Common Short Code (CSC) Administrators;
obtaining from the nationally disparate CSC Administrators information about short codes being respectively managed by the nationally disparate CSC Administrators;
aggregating the information about the short codes in a database; and
providing access to the information about the short codes via queries received from third parties.

17. The method of claim 16, wherein the information about the short codes includes a country identification and a function of a given short code.

18. The method of claim 16, further comprising processing a keyword received as part of a search request.

19. The method of claim 16, further comprising responding the queries over a channel that is different from a channel over which the queries were received.

20. The method of claim 19, wherein the queries are sent via the short message service (SMS) and responses to the queries are made available via the world wide web (WWW).
